(19) United States
(12) Patent Application Publication
(10) Pub. No.: US 2025/0373434 A1
(43) Pub. Date: Dec. 4, 2025

(54) TRUSTLESS ATTESTATION CRYPTOGRAPHIC PROOFS

(71) Applicants: Lemon Inc., Grand Cayman (KY); Beijing Zitiao Network Technology Co., Ltd., Beijing (CN)

(72) Inventors: Mingshen SUN, Culver City, CA (US); Donghang LU, Culver City, CA (US); Dayeol LEE, Culver City, CA (US); Qiang YAN, Shanghai (CN)

(21) Appl. No.: 19/222,026

(22) Filed: May 29, 2025

Related U.S. Application Data
(63) Continuation of application No. PCT/CN2024/096472, filed on May 30, 2024.

(51) Int. Cl. H04L 9/32

(52) U.S. Cl. CPC H04L 9/3221

(57) ABSTRACT

Methods, systems, and apparatus, including computer programs encoded on computer storage media, for using cryptographic proofs with attestation data. One of the methods includes maintaining attestation data for a source system; generating an attestation result using a result of verifying, using an attestation process, the attestation data for the source system; generating, using a cryptographic proving key and data for the verification process, a cryptographic proof that indicates whether the verification process was correctly executed; and providing, to a recipient system, the attestation result and the cryptographic proof.

### CROSS-REFERENCE TO RELATED APPLICATIONS

This application claims priority to PCT Application No. PCT/CN2024/096472 filed on May 30, 2024, the disclosure of which is incorporated herein by reference in its entirety.

### BACKGROUND

A device can use remote attestation as a security mechanism to verify the integrity and authenticity of a remote environment over a network. For instance, the device can use remote attestation to ensure that another system is running trusted software and has not been compromised.

### SUMMARY

When a recipient system requests data from a source system, e.g., trusted hardware, the recipient system must trust the source system to provide accurate data. In some situations, the recipient system can use a verifier system to increase trust. The verifier system can use data from the source system, and potentially other systems, to verify whether output from the source system can likely be trusted. The verifier system can then provide, to the recipient system, an attestation result that indicates whether the source system can likely be trusted. However, in these situations, the recipient system is unable to verify that the data from the verifier system can be trusted, e.g., that the verification engine has not been compromised, is not acting maliciously, or is not otherwise operating incorrectly.

The verifier system can use a zero-knowledge proof (“ZKP”) to indicate whether the recipient system can trust the verification process performed by the verifier system, e.g., that indicates whether the verification process was correctly executed, e.g., likely correctly executed. For instance, a zero-knowledge proof can be data that indicates a method by which a first entity, e.g., the verifier system or prover, proves to another party, e.g., the recipient system or ZKP verifier, that a statement is true. A zero-knowledge proof can avoid conveying information to the ZKP verifier beyond the fact of the statement is true, increasing data privacy, security, or both. Use of a zero-knowledge proof can reduce a risk that the verifier system is compromised by a malicious actor or otherwise operating incorrectly, e.g., due to a software bug. The recipient system can then receive the attestation result and the zero-knowledge proof of the verification of the attestation data. When the recipient system determines that the zero-knowledge proof is verified, the recipient system can determine to trust the attestation result. As a result, the recipient system might need to only trust the source system, e.g., the trusted hardware, given the attestation system when the zero-knowledge proof indicates that the attestation verification process was correct.

The zero-knowledge proof can be any appropriate type of data that indicates whether the verification process was likely correctly executed. For instance, the zero-knowledge proof can be data that the verifier system has that indicates that the verification process was likely correctly executed and, when provided to the recipient system, can be used by the recipient system to verify the correctness of the execution. Although the zero-knowledge proof indicates that the verification process was likely correctly executed, the zero-knowledge proof is not necessarily a value that represents a likelihood. Instead, the zero-knowledge proof is a value that the recipient system uses to verify the verification process and potential uncertainty is introduced by the use of computers, that few things can be determined with complete certainty, or a combination of both.

The subject matter described in this specification can be implemented in various implementations and may result in one or more of the following advantages. In some implementations, the systems and methods described in this specification can improve computer security, e.g., using zero-knowledge proofs (“ZKPs”), by moving an attestation service out of the trust boundary, or both. This can reduce a likelihood that a verifier system is not operating correctly, e.g., is compromised or otherwise acting maliciously, without detection by a recipient system. In some implementations, by providing a verification key in advance, the systems and methods described in this specification can reduce computational resources usage during the zero-knowledge proof verification process, e.g., reduce computational cycles, memory used, or both. In some implementations, the systems and methods described in this specification can reduce computational resource usage, entities involved in a trust process, or a combination of both. For example, by implementing components, operations, or both, of a verifier subsystem on a source subsystem that generates a result, an environment can use fewer computational resources, such as network bandwidth, CPU cycles, memory, or a combination of these, compared to other systems. In these examples, the source subsystem can perform the attestation and zero-knowledge proof operations.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which a cloud system uses zero-knowledge proofs as part of an attestation verification process.

FIG. 2 is a flow diagram of an example process for using a zero-knowledge proof.

FIG. 3 is a block diagram of a computing system that can be used in connection with computer-implemented methods described in this specification.

Like reference numbers and designations in the various drawings indicate like elements.

### DETAILED DESCRIPTION

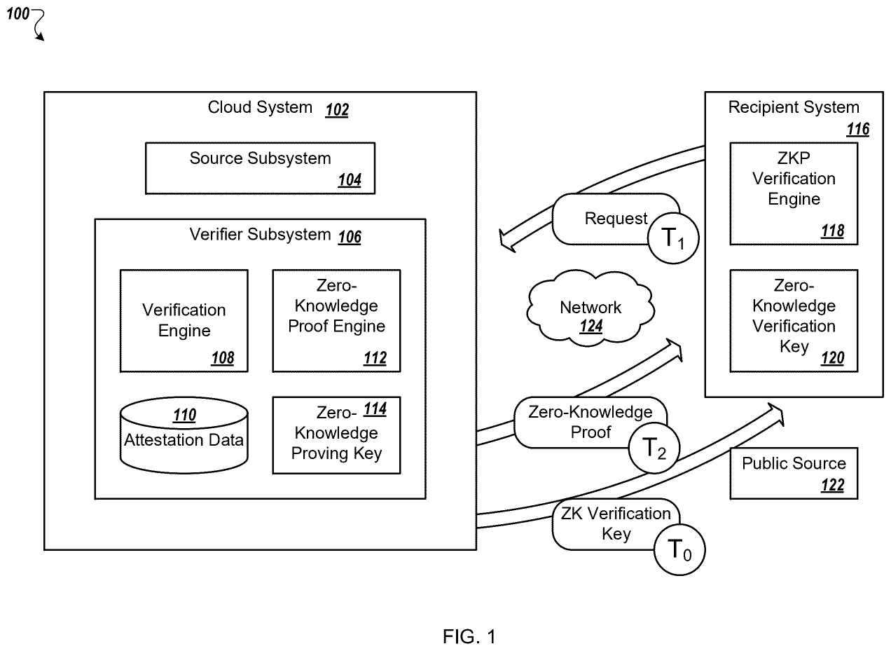

FIG. 1 depicts an example environment 100 in which a cloud system 102 uses zero-knowledge proofs as part of an attestation verification process. By providing a zero-knowledge proof to a recipient system, the cloud system 102 can increase trust in the cloud system 102, e.g., since the recipient system need not trust the cloud system's 102 processes.

The cloud system 102 can include a source subsystem 104. Although the example described with reference to the environment 100 includes the source subsystem 104 and a verifier subsystem 106 as components of the cloud system 102, in other examples one or both of the subsystems can be separate systems.

The source subsystem 104 performs one or more operations for a recipient system 116. For instance, the source subsystem 104 can receive a request, during time period T1, to perform the one or more operations. The request can include any appropriate data for the operations. The request can identify data for the operations, e.g., that will be processed as part of the operations. The request can identify code, e.g., a software application, to execute to perform the operations.

In some examples, the source subsystem 104 can include trusted hardware. For instance, the trusted hardware can implement a trusted execution environment for the recipient system 116.

To verify an integrity, authenticity, or both, of the source subsystem 104, a system needs to verify that the one or more operations executed by the source subsystem 104 were correct. To enable this verification, the source subsystem 104 can enable an attestation of the one or more operations, e.g., using attestation data. Attestation data can be used by a system to verify the correctness, e.g., the integrity or authenticity, of the one or more operations. For instance, the attestation data can indicate the operations performed, e.g., the code executed; versions of one or more applications executing on the source subsystem 104, e.g., a firmware version when the source subsystem 104 is trusted hardware; a signature for the source subsystem; or a combination of two or more of these.

Although the recipient system 116 will receive output from the source subsystem 104, and ultimately wants to rely on that output, the recipient system 116 does not perform this verification. For instance, the recipient system 116 might be unable to perform the verification. This can be a result of the computational resources available to the recipient system 116, e.g., and that any verification process performed by the recipient system 116 would take more than a threshold amount of time. In some examples, the recipient system 116 might be unable to perform the verification because it does not, e.g., cannot, have software installed for such verification.

The cloud system 102 can include the verifier subsystem 106 that verifies that the one or more operations performed by the source subsystem 104 were correct, e.g., verifies the integrity, authenticity, or both, of the source subsystem 104. For instance, a verification engine 108 included in the verifier subsystem 106 can verify the one or more operations.

As part of the attestation process, the verification engine 108 can use attestation data 110 for the source subsystem 104. The attestation data 110 can include data that indicates one or more properties of the source subsystem 104 if the source subsystem 104 is operating correctly. For instance, the attestation data 110 can include attestation signature for the source system, an attestation hash for code executed by the source system, attestation property data that indicates one or more properties for the source system, or a combination of two or more of these. The property data can indicate a most recent version of an application, e.g., firmware, installed on the source subsystem 104, e.g., an application version number.

The verifier subsystem 106 can receive the attestation data 110 from any appropriate source. For instance, the verifier subsystem 106 can receive some of the data, e.g., the signature, the property data, or both, from an entity that provides, e.g., makes, the source subsystem 104. The verifier subsystem 106 can receive some of the data from another system, e.g., a third-party system that develops software for the source subsystem 104, such as firmware.

The verification engine 108 can compare the attestation data with source evidence data received from the source subsystem 104. For instance, the source subsystem 104 can generate an output, e.g., responsive to the request from the recipient system 116, and source evidence data that represents operations performed by the source subsystem 104 during the generation. The source evidence data can have any of the types described in this specification with reference to the attestation data. The difference between the source evidence data and the attestation data is the source from which the data is received. The verifier subsystem 106 receives the attestation data from systems other than the source subsystem 104, e.g., from a manufacturer system. The verifier subsystem 106 receives the source evidence data from the source subsystem 104. The source property data indicates one or more values for at least some of the properties included in the attestation data. The source hash includes a hash of the code executed by the source subsystem 104 when performing the one or more operations to generate the output. The source signature represents a signature of the source subsystem 104, e.g., that is stored in a memory included in the source subsystem 104. The memory can be any appropriate type of memory, such as a memory that implements a database.

The verification engine 108 determines whether the attestation data and the source evidence data satisfy one or more attestation criteria. For instance, the verification engine 108 uses the comparison to determine whether there are any differences between the two data sets. The verification engine 108 can determine whether a degree in any differences satisfies the one or more attestation criteria, e.g., similarity criteria. For instance, the attestation data can require that the source subsystem 104 execute at least version 1.41 of an application while the source evidence data indicates that the source subsystem 104 executed version 1.42 of the application.

The attestation criteria can be any appropriate criteria. The attestation criteria can include an attestation criterion for each type of data in the attestation data and the source evidence data. In some examples, the attestation criteria can include multiple attestation criteria for at least some of the types of data in the attestation data and the source evidence data. Some of the attestation, e.g., similarity, criteria can require an exact match of corresponding data, e.g., for the signature and the hash. Some of the attestation criteria can define other requirements, e.g., that the software version must be at least the version identified by the attestation data and identification in the source evidence data of a more recent version passes the attestation process while an earlier version would fail the attestation process.

The analysis of data for the software code used to perform the operations can verify whether the correct operations were performed, e.g., the correct software was executed. This can be a verification of the particular version of the software code, that the software code was not likely modified, or a combination of both.

The verification engine 108 generates a result of the determination whether the attestation data and the source evidence data satisfy the one or more attestation criteria. The result can be any appropriate value. For instance, the result can be a binary value that indicates one for an attestation process pass and zero for an attestation process failure. The verification engine 108 can use other appropriate values for the result.

The verifier subsystem 106, e.g., a zero-knowledge proof engine 112, can generate a zero-knowledge proof that indicates whether the verification process was correctly executed. A zero-knowledge proof (“ZKP”) can be a cryptographic primitive. A zero-knowledge proof can enable a prover, e.g., the verifier subsystem 106, to prove the result of a computation, e.g., the verification process, without revealing any information about the inputs or intermediate steps of the computation. This can increase data privacy for data used as part of the verification process. The zero-knowledge proof engine 112 can use any appropriate zero-knowledge proof process, e.g., zero-knowledge succinct non-interactive argument of knowledge (“zk-SNARK”). For instance, the zero-knowledge proof engine 112 can implement a zero-knowledge proof circuit to verify that the verification engine 108 is behaving correctly, e.g., honestly and not maliciously.

The zero-knowledge proof engine 112 can use a zero-knowledge proving key 114 as part of the zero-knowledge proof process. For instance, the verifier subsystem 106 can maintain, in memory, the zero-knowledge proving key 114 that was previously generated, as described in more detail below. The zero-knowledge proving key 114 can be specific to the recipient system 116. In some examples, the zero-knowledge proving key 114 can be used for multiple recipient systems 116. The zero-knowledge proof engine 112 can use the zero-knowledge proving key 114 to generate the zero-knowledge proof.

The verifier subsystem 106 can transmit, during time period T2, the zero-knowledge proof to the recipient system 116. During this time period, e.g., at least partially concurrently or within a threshold time of transmission of the zero-knowledge proof, the verifier subsystem 106 can transmit the attestation result, the source subsystem 104 output, or a combination of both, to the recipient system 116. Transmission of the zero-knowledge proof to the recipient system 116 can cause the recipient system 116 to verify the zero-knowledge proof.

The recipient system 116 receives the zero-knowledge proof from the verifier subsystem 106, e.g., from the cloud system 102. A zero-knowledge proof (“ZKP”) verification engine 118 included in the recipient system 116 verifies the zero-knowledge proof. Verification of the zero-knowledge proof can use fewer computational resources than verification of the one or more operations performed by the source subsystem 104, e.g., as part of the attestation process. For instance, ZKP verification can use fewer computational cycles, less memory, less power, or a combination of two or more of these. In some examples, software code for the ZKP verification engine 118 can be less complex than software code for the verification engine 108, e.g., can include fewer lines of code. In some examples, by having the ZKP verification engine 118 on the recipient system 116 and the verification engine 108, the environment 100 can reduce the amount of computational resources used by the recipient system 116 where such resources might be scarcer than at the cloud system 102.

The ZKP verification engine 118 can use a zero-knowledge verification key 120 as part of the ZKP verification process. The recipient system 116 can access the zero-knowledge verification key 120 at any appropriate time, and from any appropriate source. For instance, during time period TO, the recipient system 116 can receive the zero-knowledge verification key 120 from the cloud system 102, can download the zero-knowledge verification key 120 from a public source 122, e.g., a file server, bulletin board, or another appropriate public source to which the zero-knowledge verification key 120 was published.

The zero-knowledge proving key 114 and the zero-knowledge verification key 120 can be generated at any appropriate time. For instance, the keys 114 and 120 can be generated at the same time or separately. The cloud system 102, e.g., the verifier subsystem 106 such as the zero-knowledge proof engine 112, can generate one or both of the zero-knowledge proving key 114 or the zero-knowledge verification key 120. In some examples, the zero-knowledge proof engine 112 can generate one or both of the keys 114, 120, e.g., during an initialization process of the zero-knowledge proof engine 112.

By using the zero-knowledge proof, the recipient system 116 can reduce a number of entities on which it relies. For instance, the recipient system 116 might need to trust the zero-knowledge proof process, e.g., the cryptographic proof process, but need not trust the verifier subsystem 106. As a result, the recipient system 116 can increase computer security; data privacy, e.g., by increasing a likelihood that the source subsystem 104 performed the correct operations on any data the source subsystem 104 received from the recipient system 116; or a combination of both.

When the zero-knowledge proof verification process passes, the recipient system 116 can determine to trust the attestation result. For instance, if the attestation result indicates that the attestation of the source subsystem 104 output passes, the recipient system 116 can determine to use, e.g., trust, the output from the source subsystem. If the attestation result indicates that the attestation of the source subsystem 104 output fails, the recipient system 116 can determine to not use, e.g., to discard, the output from the source subsystem.

In examples in which the attestation result fails, the recipient system 116 can determine one or more operations to perform. These operations can include finding another source subsystem 104 to perform operations for the recipient system 116, e.g., finding another trusted hardware manufacturer; finding another cloud system 102 to perform operations for the recipient system 116; performing one or more computer security operations, e.g., reporting the failure to another entity; or a combination of two or more of these.

The recipient system 116 can send any reports to a reporting system, e.g., a subsystem of the cloud system 102 or another system. The reporting system can be for a security entity, e.g., to which potential security concerns are reported for further analysis.

When the zero-knowledge proof verification process does not pass, e.g., fails, the recipient system 116 can determine to not trust the attestation result. The recipient system 116 can perform one or more operations, such as transmitting a message to an entity, e.g., a security entity, indicating the failure; determining to stop communicating with the cloud system 102; or a combination of both. The message can include the failed zero-knowledge proof. In instances in which the zero-knowledge verification key 120 was accessed from a public source, providing the zero-knowledge proof to a security entity can enable the security entity to confirm the failure of the zero-knowledge proof.

The time periods T0, T1, and T2 can occur in any appropriate order, overlap at least in part, or a combination of both. For instance, the time period TO can occur at least partially concurrently with time period T2.

In some implementations, the source subsystem 104 can perform one or more operations of the verifier subsystem 106. For instance, the one or more computers that implement the source subsystem 104 can also implement the verifier subsystem 106.

The cloud system 102 and the recipient system 116, optionally including any subsystems, are examples of a system implemented as computer programs on one or more computers in one or more locations, in which the systems, components, and techniques described in this specification are implemented. In some examples, the recipient system 116 can include a single device, such as a personal computer, a mobile communication device, or another device that can send and receive data over a network 124. The network 124, such as a local area network (“LAN”), wide area network (“WAN”), the Internet, or a combination thereof, connects the cloud system 102, the recipient system 116, and the public source 122. The systems 102, 116, or both, can use a single computer or multiple computers operating in conjunction with one another, including, for example, a set of remote computers deployed as a cloud computing service.

The T cloud system 102 and the recipient system 116 can include several different functional components, including the verification engine 108, the zero-knowledge proof engine 112, and the ZKP verification engine 118. The verification engine 108, the zero-knowledge proof engine 112, the ZKP verification engine 118, or a combination of these, can include one or more data processing apparatuses, can be implemented in code, or a combination of both. For instance, each of the verification engine 108, the zero-knowledge proof engine 112, and the ZKP verification engine 118 can include one or more data processors and instructions that cause the one or more data processors to perform the operations discussed herein.

The various functional components of the cloud system 102 and the recipient system 116 can be installed on one or more computers as separate functional components or as different modules of a same functional component. For example, the components of the cloud system 102 and the recipient system 116 can be implemented as computer programs installed on one or more computers in one or more locations that are coupled to each through a network. In cloud-based systems for example, these components can be implemented by individual computing nodes of a distributed computing system.

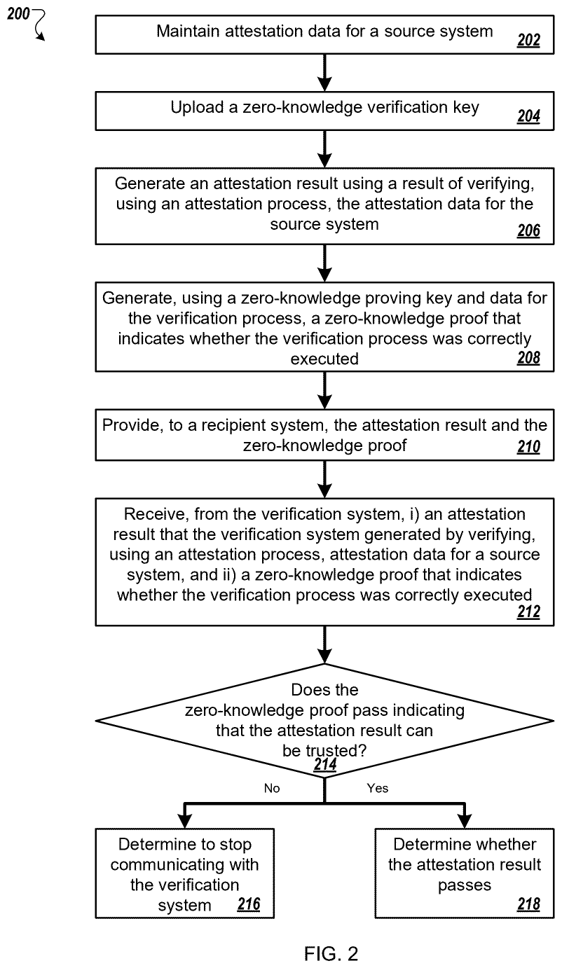

FIG. 2 is a flow diagram of an example process 200 for using a zero-knowledge proof. For example, various operations in the process 200 can be used by the verifier subsystem 106 and the recipient system 116 from the environment 100.

A verifier system, e.g., subsystem, maintains attestation data for a source system (202). For instance, the verifier system can receive the attestation data from one or more other systems. The other systems can include the source system, a manufacturer system, e.g., for a manufacturer of at least a portion of the source system, another appropriate system, or a combination of these.

The verifier system uploads a zero-knowledge verification key (204). The verifier system can generate one or more keys, e.g., a verification key and a proving key, for a zero-knowledge proof process. The verifier system can upload the zero-knowledge verification key to any appropriate system, e.g., a recipient system or a public system from which the recipient system can retrieve the zero-knowledge verification key. In some examples, one or both of the keys are not required to be secret.

In some implementations, the verifier system includes a verification engine that verifies attestation data for the source system using an attestation process. The verification engine can implement the attestation process as a circuit, e.g., implemented in hardware, software, or a combination of both. The verifier system can apply zero-knowledge proof initialization to the circuit. In some examples, the application of the zero-knowledge proof initialization to the circuit can generate one or both of the zero-knowledge verification key or the zero-knowledge proving key.

Uploading the zero-knowledge verification key can use an authenticated channel. For instance, the verifier system can distribute the zero-knowledge verification key to the recipient system, e.g., as a relying party, through the authenticated channel by publishing the zero-knowledge verification key on a public bulletin board with signatures.

The verifier system can distribute the zero-knowledge proving key. For instance, the verifier system, e.g., the verification engine, can provide the zero-knowledge proving key to the zero-knowledge proof engine, e.g., as an attestation service.

The verifier system generates an attestation result using a result of verifying, using an attestation process, the attestation data for the source system (206). For example, the verification engine can perform any appropriate attestation process. The verifier system, e.g., the verification engine, can verify one or more data sets for the source system. The data sets can include a signature, one or more software versions, code, or a combination of two or more of these.

In some examples, the verification engine can determine whether a signature for the source subsystem is likely correct. For instance, the verification engine can maintain, as part of the attestation data for the source system, an attestation signature for the source system. The verification engine can receive, from the source system, a source signature for the source system. The verification system can receive the source signature with the output from the source system that is intended for the recipient system. The verification engine can compare the attestation signature and the source signature to determine whether any differences between the signatures satisfy one or more similarity criteria.

The signature can be any appropriate type of signature for the source system. For instance, the signature can have an Edwards-curve Digital Signature Algorithm (“EdDSA”) signature scheme.

In some examples, the verification engine can determine whether property data satisfies one or more attestation criteria. The property data can indicate one or more properties for the source system, such as a software version of code executing on the source system. In this example, the attestation criteria can require that the software version, as a type of property data, be a most recent software version, at least a particular version of software, e.g., that was tested for security compliance, or a combination of these. The verifier system can receive source property data from the source system. In some examples, the verifier system can receive the attestation property data from another system, such as a manufacturer of hardware included in the source system, a vendor for software installed on the source system, or a combination of both. In some examples, the attestation criteria comprises the attestation property data, e.g., when the criteria themselves define the requirements for the property data and no other data is required. The verification engine can determine whether the property data for the source system satisfy the one or more attestation criteria.

In some examples, the verification engine can determine whether a source hash of executed code matches an attestation hash for the code. The attestation hash can be a hash of the code that the source system uses to perform the one or more operations to generate output. At least some of the code can be code previously stored on the source system, e.g., during a manufacturing process for the source system. At least some of the code can be code provided to the source system after manufacturing, e.g., as part of a request to perform operations provided by the recipient system. For instance, the recipient system can provide the request to the source system. The request can include or otherwise identify the code. In some examples, the verifier system can receive a copy of the request, the code, or both, from the recipient system. In some examples, the verifier system can receive the attestation hash from the recipient system. In these examples, the source system can receive data, from the recipient system, that indicates a hash process used to generate the hash. As a result, the source system can generate a hash using the hash process and provide the hash, as the source hash, to the verifier system for verification using the attestation process. The verifier system can determine whether the source hash and the attestation hash, or a difference between the two hashes, satisfies one or more attestation, e.g., similarity, criteria.

The verification engine can determine whether the attestation process passes using results of determinations whether various attestation criteria are satisfied. If all the attestation criteria are satisfied, the verification engine can determine that the attestation process passes. If at least one of the attestation criteria is not satisfied, the verification engine can determine that the attestation process does not pass. The verification engine can generate the attestation result that indicates whether the attestation process passes.

The verifier system generates, using a zero-knowledge proving key and data for the verification process, a zero-knowledge proof that indicates whether the verification process was correctly executed (208). The zero-knowledge proof engine can generate the zero-knowledge proof at any appropriate time. For instance, the zero-knowledge proof engine can generate the zero-knowledge proof after, at least partially concurrently with, or a combination of both, generation of the attestation result. The zero-knowledge proof can include data that indicates that the attestation process was correctly executed, e.g., given corresponding input values for the operations performed by the source system.

The verifier system provides, to a recipient system, the attestation result and the zero-knowledge proof (210). For instance, the verifier system, or a component of the verifier system, can create a message that includes the attestation result and the zero-knowledge proof. The verifier system can send, in one or more packets, the data for the message.

The recipient system receives, from the verification system, i) an attestation result that the verification system generated by verifying, using an attestation process, attestation data for a source system, and ii) a zero-knowledge proof that indicates whether the verification process was correctly executed (212). For example, the recipient system receives the one or more packets for the message that includes the attestation result and the zero-knowledge proof. In some examples, the recipient system receives the attestation result and the zero-knowledge proof as separate messages, multiple messages for each, or a combination of both.

The recipient system determines whether the zero-knowledge proof passes indicating that the attestation result can be trusted (214). For instance, the recipient system can verify the correctness of the attestation process by verifying the zero-knowledge proof. The recipient system, e.g., the zero-knowledge proof verification engine, can perform this verification using the attestation result as input to the process. In some examples, the recipient system can use the zero-knowledge verification key as input to the zero-knowledge proof verification process.

The recipient system determines to stop communicating with the verification system (216). For instance, in response to determining that the zero-knowledge proof does not pass, e.g., is invalid, the recipient system can perform one or more operations. These operations can include determining to stop communicating with the verification system, determining to stop communicating with the source system, sending a notification to a reporting system, e.g., a security system, indicating that the proof did not pass, another appropriate operation, or a combination of two or more of these.

The recipient system determines whether the attestation result passes (218). For example, in response to determining that the zero-knowledge proof passes, e.g., is valid, the recipient system can analyze the attestation result. When the attestation result passes, the recipient system can use the output from the source system, e.g., in any appropriate manner.

The order of operations in the process 200 described above is illustrative only, and using the zero-knowledge proof can be performed in different orders. For example, the process 200 can include operation 204 before operation 202.

In some implementations, the process 200 can include additional operations, fewer operations, or some of the operations can be divided into multiple operations. For example, the process can include operations 202 through 210. The process can include operations 202 (optionally), 206, and 208, optionally with operation 210. The process can include operations 212 and 214, optionally with one or more of operation 216 or 218. In some examples, the process can include operations 206 through 214.

In some implementations, the systems and methods described in this specification can use a cryptographic proof other than a zero-knowledge proof. For instance, the verifier system and recipient system can use another type of interactive proof, such as a reduction proof, or a private-key cryptosystem.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

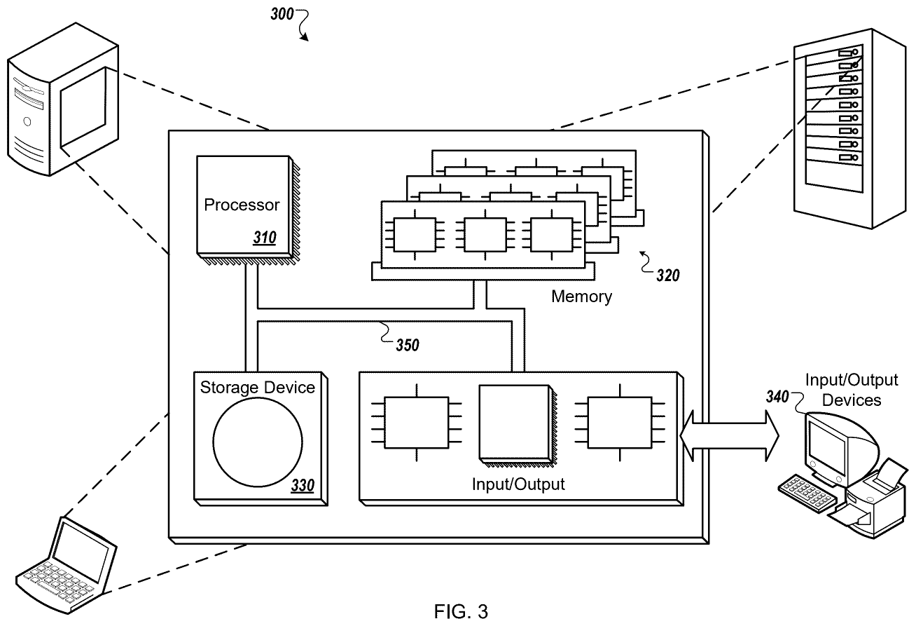

An example of one such type of computer is shown in FIG. 3, which shows a schematic diagram of a computer system 300. The computer system 300 can be used for the operations described in association with any of the computer-implemented methods described previously, according to some implementations. The computer system 300 includes a processor 310, a memory 320, a storage device 330, and an input/output device 340. Each of the components 310, 320, 330, and 340 are interconnected using a system bus 350. The processor 310 is capable of processing instructions for execution within the computer system 300. In one implementation, the processor 310 is a single-threaded processor. In another implementation, the processor 310 is a multi-threaded processor. The processor 310 is capable of processing instructions stored in the memory 320 or on the storage device 330 to display graphical information for a user interface on the input/output device 340.

The memory 320 stores information within the computer system 300. In some implementations, the memory 320 is a computer-readable medium. In some implementations, the memory 320 is a volatile memory unit. In some implementations, the memory 320 is a non-volatile memory unit.

The storage device 330 is capable of providing mass storage for the computer system 300. In some implementations, the storage device 330 is a computer-readable medium. In some implementations, the storage device 330 can be a floppy disk device, a hard disk device, an optical disk device, or a tape device.

The input/output device 340 provides input/output operations for the computer system 300. In some implementations, the input/output device 340 includes a keyboard, a pointing device, a touchscreen, or a combination of these. In some implementations, the input/output device 340 includes a display unit for displaying graphical user interfaces. In some implementations, the input/output device 340 includes a microphone, a speaker, or a combination of both.

In addition to the embodiments of the attached claims and the embodiments described above, the following numbered embodiments are also innovative.

Embodiment 1 is a method that includes maintaining attestation data for a source system; generating an attestation result using a result of verifying, using an attestation process, the attestation data for the source system; generating, using a cryptographic proving key and data for the verification process, a cryptographic proof that indicates whether the verification process was correctly executed; and providing, to a recipient system, the attestation result and the cryptographic proof.

Embodiment 1 may provide one or more of the following technical advantages or effects: improved security for the recipient system.

Embodiment 2 is the method of embodiment 1, wherein: providing the cryptographic proof can include providing the cryptographic proof that comprises a cryptographic primitive and enables the recipient system to verify, using the cryptographic primitive, the verification process for the attestation data.

Embodiment 2 may provide one or more of the following technical advantages or effects: improved security for the recipient system.

Embodiment 3 is the method of any of embodiments 1-2, wherein: the cryptographic proof can be a zero-knowledge proof.

Embodiment 3 may provide one or more of the following technical advantages or effects: improved security for the recipient system.

Embodiment 4 is the method of any of embodiments 1-3, wherein: providing the cryptographic proof can include providing, to the recipient system, the cryptographic proof to cause the recipient system to verify the cryptographic proof using a cryptographic verification key.

Embodiment 4 may provide one or more of the following technical advantages or effects: improved security for the recipient system.

Embodiment 5 is the method of embodiment 4, wherein: providing the cryptographic proof comprises providing, to the recipient system, the cryptographic proof to cause the recipient system to verify the cryptographic proof using the cryptographic verification key that was previously provided to the recipient system.

Embodiment 5 may provide one or more of the following technical advantages or effects: improved security for the recipient system.

Embodiment 6 is the method of embodiment 4, wherein: providing the cryptographic proof can include providing, to the recipient system, the cryptographic proof to cause the recipient system to verify the cryptographic proof using that cryptographic verification key that was retrieved from a public source.

Embodiment 6 may provide one or more of the following technical advantages or effects: improved security for the recipient system, enabling multiple different systems to use the security features given the public source, or both.

Embodiment 7 is the method of embodiment 6, the method including: uploading the cryptographic verification key to the public source.

Embodiment 7 may provide one or more of the following technical advantages or effects: improved security for the recipient system.

Embodiment 8 is the method of any of embodiments 4-7, the method including: generating the cryptographic proving key and the cryptographic verification key.

Embodiment 8 may provide one or more of the following technical advantages or effects: improved security for the recipient system.

Embodiment 9 is the method of embodiment 8, wherein: generating the cryptographic proving key and the cryptographic verification key can occur before generating the attestation result.

Embodiment 9 may provide one or more of the following technical advantages or effects: improved security for the recipient system.

Embodiment 10 is the method of any of embodiments 1-9, wherein: the source system can include trusted hardware that performed one or more computations for the recipient system; and generating the attestation result can verify the attestation data for the one or more computations the source system performed for the recipient system.

Embodiment 10 may provide one or more of the following technical advantages or effects: improved security for the recipient system given the trusted hardware that performed the computations, increased trust of the trusted hardware, or both.

Embodiment 11 is the method of any of embodiments 1-10, wherein: maintaining the attestation data for the source system can include maintaining one or more of an attestation signature for the source system, an attestation hash for code executed by the source system, or attestation property data that indicates one or more properties for the source system; verifying the attestation data can include: receiving, from the source system, output and source evidence data that represents one or more of a source signature, a source hash that represents code executed by the source system, or source property data for the one or more properties for the source system; and determining whether the attestation data and the source evidence data satisfy one or more similarity criteria; and generating the attestation result using the result of the determination whether the attestation data and the source evidence data satisfy one or more similarity criteria.

Embodiment 11 may provide one or more of the following technical advantages or effects: improved security for the recipient system, increased trust of the source system, or both.

Embodiment 12 is a method that includes receiving, from a verifier system, i) an attestation result that the verifier system generated by verifying, using an attestation process, attestation data for a source system, and ii) a cryptographic proof that indicates whether the verification process was correctly executed; before determining whether the attestation result passes, determining, using a cryptographic verification key, whether the cryptographic proof passes providing an indication that the attestation result is trusted; and performing one or more operations using a result of the determination whether the cryptographic proof passes.

Embodiment 12 may provide one or more of the following technical advantages or effects: improved security for the recipient system, reduced computational cycles given the order of the operations, or both.

Embodiment 13 is the method of any of embodiments 12, wherein: performing the one or more operations comprises: in response to determining that the cryptographic proof passes and the attestation result can be trusted, determining whether the attestation result passes; and performing one or more second operations using a result of the determination whether the attestation result passes.

Embodiment 13 may provide one or more of the following technical advantages or effects: improved security for the recipient system.

Embodiment 14 is the method of embodiment 13, wherein: performing the one or more second operations comprises: in response to determining that the attestation result does not pass, discarding output generated by the source system.

Embodiment 14 may provide one or more of the following technical advantages or effects: improved security for the recipient system, reduced computational resource, e.g., memory or network traffic, usage, or a combination of both.

Embodiment 15 is the method of any of embodiments 13-14, wherein: performing the one or more second operations comprises: in response to determining that the attestation result does not pass, selecting another source system from which to request output data.

Embodiment 15 may provide one or more of the following technical advantages or effects: improved security for the recipient system.

Embodiment 16 is the method of any of embodiment 13, wherein: performing the one or more second operations comprises: in response to determining that the attestation result passes, using an output generated by the source system.

Embodiment 16 may provide one or more of the following technical advantages or effects: improved security for the recipient system.

Embodiment 17 is the method of any of embodiments 12-16, wherein: the cryptographic proof comprises a zero-knowledge proof.

Embodiment 17 may provide one or more of the following technical advantages or effects: improved security for the recipient system.

Embodiment 18 is the method of any of embodiments 12-17, wherein: performing the one or more operations comprises: in response to determining that the cryptographic proof does not pass and the attestation result should not be trusted, discarding the attestation result.

Embodiment 18 may provide one or more of the following technical advantages or effects: improved security for the recipient system, reduced computational resource, e.g., memory or network traffic, usage, or a combination of both.

Embodiment 19 is the method of any of embodiments 12-18, wherein: performing the one or more operations comprises: in response to determining that the cryptographic proof does not pass and the attestation result should not be trusted, determining to stop communicating with one or more of the verifier system or the source system.

Embodiment 19 may provide one or more of the following technical advantages or effects: improved security for the recipient system.

Embodiment 20 is the method of any of embodiments 12-19, wherein: performing the one or more operations comprises: in response to determining that the cryptographic proof does not pass and the attestation result should not be trusted, sending, to a reporting system, data indicating that the cryptographic proof did not pass.

Embodiment 20 may provide one or more of the following technical advantages or effects: improved security for other systems, e.g., when the reporting system might be able to reduce potential communication with the verification system.

Embodiment 21 is the method of embodiments 20, wherein: sending the data comprises sending, to the reporting system, the cryptographic proof.

Embodiment 21 may provide one or more of the following technical advantages or effects: increased accuracy of the failed cryptographic proof.

Embodiment 22 is the method of any of embodiments 20-21, wherein: sending the data comprises sending, to the reporting system, the cryptographic verification key.

Embodiment 22 may provide one or more of the following technical advantages or effects: increased accuracy of the failed cryptographic proof.

Embodiment 23 is the method of any of embodiments 12-22, comprising: accessing the cryptographic verification key that was generated with a cryptographic proving key used to generate the cryptographic proof.

Embodiment 23 may provide one or more of the following technical advantages or effects: improved security for the recipient system.

Embodiment 24 is the method of embodiment 23, comprising: receiving the cryptographic verification key from the verifier system.

Embodiment 24 may provide one or more of the following technical advantages or effects: improved security for the recipient system.

Embodiment 25 is the method of embodiment 23, comprising: retrieving the cryptographic verification key from a public source to which the cryptographic verification key was uploaded.

Embodiment 25 may provide one or more of the following technical advantages or effects: improved security for the recipient system.

Embodiment 26 is the method of any of embodiments 12-25, wherein: the verifier system and source system both comprise subsystems of the same cloud system.

Embodiment 26 may provide one or more of the following technical advantages or effects: improved security for the recipient system, reduced computational resource usage, e.g., for communications between the two subsystems, or both.

Embodiment 27 is a method that includes maintaining attestation data for a source system; generating an attestation result using a result of verifying, using an attestation process, the attestation data for the source system; generating, using a cryptographic proving key and data for the verification process, a cryptographic proof that indicates whether the verification process was correctly executed; providing, to a recipient system, the attestation result and the cryptographic proof; receiving, from a verifier system, i) an attestation result that the verifier system generated by verifying, using an attestation process, attestation data for a source system, and ii) a cryptographic proof that indicates whether the verification process was correctly executed; before determining whether the attestation result passes, determining, using a cryptographic verification key, whether the cryptographic proof passes and the attestation result can be trusted; and performing one or more operations using a result of the determination whether the cryptographic proof passes.

Embodiment 27 may provide one or more of the following technical advantages or effects: improved security for the recipient system.

Embodiment 28 is a system comprising: one or more computers and one or more storage devices storing instructions that are operable, when executed by the one or more computers, to cause the one or more computers to perform the method of any one of embodiments 1 to 27.

Embodiment 29 is a computer program carrier encoded with a computer program, the program comprising instructions that are operable, when executed by one or more computers, to cause the one or more computers to perform the method of any one of embodiments 1 to 27.

Embodiment 30 is the computer program carrier of embodiment 29, wherein the computer program carrier is a propagated, e.g., non-transitory, signal.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures, such as spreadsheets, relational databases, or structured files, may be used.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A computer-implemented method comprising:
maintaining attestation data for a source system;
generating an attestation result using a result of verifying, using an attestation process, the attestation data for the source system;
generating, using a cryptographic proving key and data for the verification process, a cryptographic proof that indicates whether the verification process was correctly executed; and
providing, to a recipient system, the attestation result and the cryptographic proof.

2. The method of claim 1, wherein providing the cryptographic proof comprises providing the cryptographic proof that comprises a cryptographic primitive and enables the recipient system to verify, using the cryptographic primitive, the verification process for the attestation data.

3. The method of claim 2, wherein the cryptographic proof comprises a zero-knowledge proof.

4. The method of claim 1, wherein providing the cryptographic proof comprises providing, to the recipient system, the cryptographic proof to cause the recipient system to verify the cryptographic proof using a cryptographic verification key.

5. The method of claim 4, wherein providing the cryptographic proof comprises providing, to the recipient system, the cryptographic proof to cause the recipient system to verify the cryptographic proof using the cryptographic verification key that was previously provided to the recipient system.

6. The method of claim 4, wherein providing the cryptographic proof comprises providing, to the recipient system, the cryptographic proof to cause the recipient system to verify the cryptographic proof using that cryptographic verification key that was retrieved from a public source.

7. The method of claim 6, comprising uploading the cryptographic verification key to the public source.

8. The method of claim 4, comprising generating the cryptographic proving key and the cryptographic verification key.

9. The method of claim 8, wherein generating the cryptographic proving key and the cryptographic verification key occurs before generating the attestation result.

10. The method of claim 1, wherein:
the source system comprises trusted hardware that performed one or more computations for the recipient system; and
generating the attestation result verifies the attestation data for the one or more computations the source system performed for the recipient system.

11. The method of claim 1, wherein:
maintaining the attestation data for the source system comprises maintaining one or more of an attestation signature for the source system, an attestation hash for code executed by the source system, or attestation property data that indicates one or more properties for the source system;
verifying the attestation data comprises:
receiving, from the source system, output and source evidence data that represents one or more of a source signature, a source hash that represents code executed by the source system, or source property data for the one or more properties for the source system; and
determining whether the attestation data and the source evidence data satisfy one or more similarity criteria; and
generating the attestation result using the result of the determination whether the attestation data and the source evidence data satisfy one or more similarity criteria.

12. A computer-implemented method comprising:
receiving, from a verifier system, i) an attestation result that the verifier system generated by verifying, using an attestation process, attestation data for a source system, and ii) a cryptographic proof that indicates whether the verification process was correctly executed;
before determining whether the attestation result passes, determining, using a cryptographic verification key, whether the cryptographic proof passes providing an indication that the attestation result is trusted; and
performing one or more operations using a result of the determination whether the cryptographic proof passes.

13. The method of claim 12, wherein performing the one or more operations comprises:
in response to determining that the cryptographic proof passes and the attestation result can be trusted, determining whether the attestation result passes; and
performing one or more second operations using a result of the determination whether the attestation result passes.

14. The method of claim 13, wherein performing the one or more second operations comprises:
in response to determining that the attestation result does not pass, discarding output generated by the source system.

15. The method of claim 13, wherein performing the one or more second operations comprises at least one of:
in response to determining that the attestation result does not pass, selecting another source system from which to request output data,
in response to determining that the attestation result passes, using an output generated by the source system,
in response to determining that the cryptographic proof does not pass and the attestation result should not be trusted, discarding the attestation result,
in response to determining that the cryptographic proof does not pass and the attestation result should not be trusted, determining to stop communicating with one or more of the verifier system or the source system, or
in response to determining that the cryptographic proof does not pass and the attestation result should not be trusted, sending, to a reporting system, data indicating that the cryptographic proof did not pass.

16. The method of claim 15, wherein sending the data comprises at least one of:
sending, to the reporting system, the cryptographic proof;
sending, to the reporting system, the cryptographic verification key.

17. The method of claim 12, comprising:
accessing the cryptographic verification key that was generated with a cryptographic proving key used to generate the cryptographic proof.

18. The method of claim 17, comprising at least one of:
receiving the cryptographic verification key from the verifier system, or
retrieving the cryptographic verification key from a public source to which the cryptographic verification key was uploaded.

19. The method of claim 12, wherein the verifier system and source system both comprise subsystems of the same cloud system.

20. A computer-implemented method comprising:
maintaining attestation data for a source system;
generating an attestation result using a result of verifying, using an attestation process, the attestation data for the source system;
generating, using a cryptographic proving key and data for the verification process, a cryptographic proof that indicates whether the verification process was correctly executed;
providing, to a recipient system, the attestation result and the cryptographic proof;
receiving, from a verifier system, i) an attestation result that the verifier system generated by verifying, using an attestation process, attestation data for a source system, and ii) a cryptographic proof that indicates whether the verification process was correctly executed;
before determining whether the attestation result passes, determining, using a cryptographic verification key, whether the cryptographic proof passes and the attestation result can be trusted; and
performing one or more operations using a result of the determination whether the cryptographic proof passes.
